(19) United States
(12) Patent Application Publication
(10) Pub. No.: US 2020/0286694 A1
(43) Pub. Date: Sep. 10, 2020

(54) Seal Structure Including Sealing Member Provided with Protrusion and Switch Device Having Seal Structure

(71) Applicant: TOYO DENSO KABUSHIKI KAISHA, Minato-ku (JP)

(72) Inventors: Daisuke MOTOKI, Sakado-shi (JP); Shingo MIYAYAMA, Sakado-shi (JP)

(73) Assignee: TOYO DENSO KABUSHIKI KAISHA

(21) Appl. No.: 16/725,067

(22) Filed: Dec. 23, 2019

(30) Foreign Application Priority Data
Mar. 7, 2019 (JP) 2019-041774

(51) Int. Cl. H01H 9/04; F16J 15/10; F16J 15/06

(52) U.S. Cl. CPC H01H 9/04; F16J 15/061; F16J 15/104

(57) ABSTRACT

A seal structure that secures sufficient sealing function even under a situation that causes a tilt of a sealing member in the seal structure. The seal structure includes a case, a cover, and a sealing member on which pressure acts while being sandwiched between the case and the cover. The sealing member includes a main body, a first protrusion protruding from the main body toward the case, and a second protrusion protruding from the main body toward the cover. The case includes a first recess that comes into contact with the first protrusion, and the cover includes a second recess that comes into contact with the second protrusion. The first protrusion and the first recess are different in shape. Furthermore, the second protrusion and the second recess are different in shape.

### BACKGROUND OF THE INVENTION

### Field of the Invention

The present invention relates to a seal structure including a sealing member provided with a protrusion and relates to a switch device having the seal structure.

### Description of the Related Art

For example, in a seal structure, when two members are fixed with a sealing member sandwiched between the two members, pressure acts on the sealing member, leading to compression of the sealing member. Such a configuration secures sealing function. As a related technique, there is proposed a seal structure in which a gap between two members is sealed with a gasket having a pair of curved sealing surfaces (see Japanese Laid-open Patent Publication (Kokai) No. 2006-200649). In this seal structure, the gasket including a pair of protrusions is mounted on a mounting groove disposed in one of the two members.

In the seal structure proposed in Japanese Laid-open Patent Publication (Kokai) No. 2006-200649, as described above, the gasket is mounted on the mounting groove disposed in one of the two members. The pair of protrusions disposed in the gasket comes into contact with both side surfaces of the mounting groove. Accordingly, it is required to provide a deep mounting groove to one of the two members so as to house almost the entire gasket. For example, neither of the two members that compress the gasket may have a margin for the mounting groove that houses almost the entire gasket. In such a case, when the gasket is attached to the two members, the gasket may be tilted. If the two members sandwiching the gasket are fixed while the gasket is tilted, it is difficult to obtain a sufficient sealing effect. In the seal structure disclosed in Japanese Laid-open Patent Publication (Kokai) No. 2006-200649, pressure from the two members acts on the sealing surfaces of the gasket and does not act on the protrusions of the gasket.

### SUMMARY OF THE INVENTION

The present invention provides a seal structure that secures sufficient sealing function even under a situation that causes a tilt of a sealing member in the seal structure and provides a switch device including the seal structure.

Accordingly, an aspect of the present invention provides a seal structure and a switch device including: a first member; a second member; a sealing member on which pressure acts while being sandwiched between the first member and the second member; wherein the sealing member includes a main body, a first protrusion protruding from the main body toward the first member, and a second protrusion protruding from the main body toward the second member, the first member includes a first recess that comes into contact with the first protrusion, the second member includes a second recess that comes into contact with the second protrusion, the first protrusion and the first recess are different in shape, and the second protrusion and the second recess are different in shape.

The present invention secures sufficient sealing function even under a situation that causes a tilt of the sealing member in the seal structure.

Further features of the present invention will become apparent from the following description of exemplary embodiments (with reference to the attached drawings).

### BRIEF DESCRIPTION OF THE DRAWINGS

FIG. 1 is an exploded perspective view showing an example of a component having sealing function.

FIG. 2 is a cross-sectional view showing a seal structure according to an embodiment of the present invention.

FIG. 3 is a cross-sectional view showing the seal structure according to an embodiment of the present invention when a case and a cover are fixed.

FIG. 4 is a partial expanded view of the seal structure shown in FIG. 2.

FIG. 5 is a cross-sectional view showing a seal structure according to a first variation.

FIG. 6 is a cross-sectional view showing a seal structure according to a second variation.

FIG. 7 is a cross-sectional view showing a seal structure according to a third variation.

FIG. 8 is a cross-sectional view showing a state where a case and a cover are fixed in the third variation.

### DESCRIPTION OF THE EMBODIMENTS

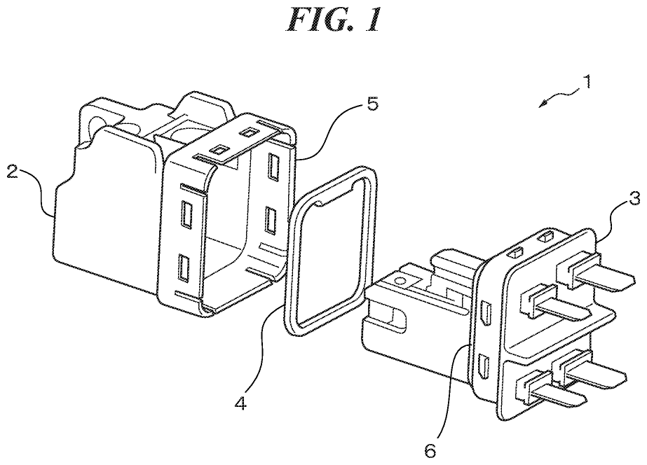

Embodiments of the present invention will now be described with reference to the drawings. It should be noted that the scope of the present invention is not limited to the configurations described in the following embodiments. FIG. 1 is an exploded perspective view showing an example of a component 1 having sealing function. The component 1 in FIG. 1 may be a singular component or may be a component included in a part of a device. Hereinafter, the component 1 will be described as a component included in a part of a switch device for starting or stopping the engine of an automobile. However, the component 1 is not limited to a component of a switch device for starting or stopping the engine of an automobile.

The component 1 includes a case 2, a cover 3, and a sealing member 4 sandwiched between the case 2 and the cover 3. The case 2 is a cylindrical member in which, for example, electric components are housed. The cover 3 is a member having a shape that fits into the case 2. In FIG. 1, the cover 3 includes a plurality of conductors of a power plug on a surface opposite to the case 2. For example, currents are carried between the electric components housed inside the case 2 and the conductors of the cover 3. One of the case 2 and the cover 3 corresponds to a first member and the other corresponds to a second member.

The sealing member 4 is fixed while being sandwiched between the case 2 and the cover 3. In the example shown in FIG. 1, since the case 2 has a substantially rectangular cross section, the sealing member 4 is shaped into a substantially rectangular ring. However, the sealing member 4 may not be shaped into a substantially rectangular ring. For example, the sealing member 4 may be shaped into an annular O-ring. The case 2 and the cover 3 are fixed by any technique such as hooking or screw fastening. The case 2 is provided with a first contact portion 5 with which one surface of the sealing member 4 comes into contact. Furthermore, the cover 3 is provided with a second contact portion 6 with which the other surface of the sealing member 4 comes into contact. The first contact portion 5 of the case 2 and the second contact portion 6 of the cover 3 double as sealed portions with which the sealing member 4 comes into contact.

The sealing member 4 is a member having flexibility to some extent. The sealing member 4 is attached to be in contact with the first contact portion 5 and the second contact portion 6. With regard to the attachment of the sealing member 4, for example, first, the sealing member 4 is mounted on the second contact portion 6 of the cover 3 by hand or a robot, and then, the cover 3 and the sealing member 4 are attached to the case 2. When the case 2 and the cover 3 are fixed, pressure acts on the sealing member 4 from both the case 2 and the cover 3, which compresses the sealing member 4. The component 1 is configured in this manner. Since the component 1 is sealed by the sealing member 4, the inside of the component 1 is airtight. Accordingly, the sealing member 4 secures a waterproof function.

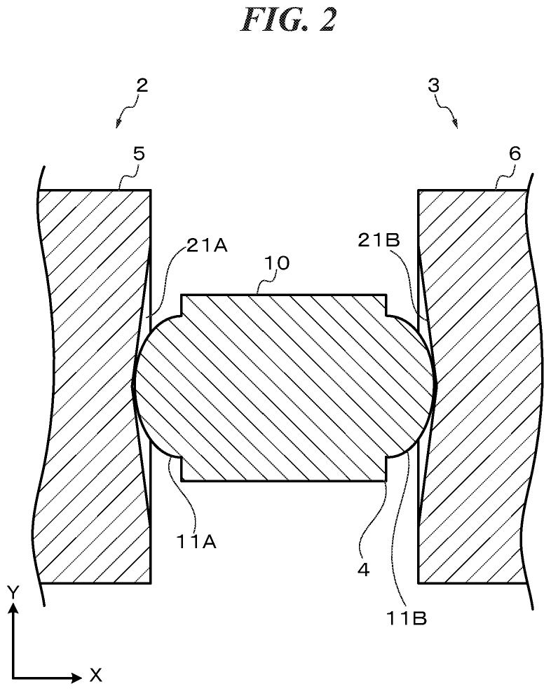

FIG. 2 is a cross-sectional view showing the seal structure when the sealing member 4 is sandwiched between the case 2 and the cover 3. In the state shown in FIG. 2, the case 2 and the cover 3 are not fixed. Accordingly, pressure from the case 2 and the cover 3 does not act on the sealing member 4, and the sealing member 4 is not compressed.

The sealing member 4 includes a main body 10, a first protrusion 11A, and a second protrusion 11B. The main body 10 is a part forming the body of the sealing member 4 and has a substantially rectangular cross section. The first protrusion 11A and the second protrusion 11B are protruding arches when viewed in cross section. The first protrusion 11A protrudes toward the case 2. The second protrusion 11B protrudes toward the cover 3. As described above, the case 2 is provided with the first contact portion 5, and the cover 3 is provided with the second contact portion 6. The first contact portion 5 of the case 2 is provided with a first recess 21A having a substantially V-shaped cross section. The second contact portion 6 of the cover 3 is provided with a second recess 21B having a substantially V-shaped cross section. The first recess 21A and the second recess 21B are depressions each formed by two inclined planes.

In the X-axis direction shown in FIG. 2, the first protrusion 11A and the second protrusion 11B protrude symmetrically from the main body 10. Furthermore, in the X-axis direction, the first recess 21A and the second recess 21B are recessed symmetrically across the sealing member 4.

Here, the first protrusion 11A has an arch-shaped cross section and the first recess 21A has a substantially V-shaped cross section. Accordingly, those members are different in shape. Similarly, the second protrusion 11B has an arch-shaped cross section and the second recess 21B has a substantially V-shaped cross section. Accordingly, those members are different in shape. When the sealing member 4 is sandwiched between the case 2 and the cover 3, the vertex of the first protrusion 11A of the sealing member 4 is guided to the most recessed portion of the first recess 21A. Similarly, when the sealing member 4 is sandwiched between the case 2 and the cover 3, the vertex of the second protrusion 11B of the sealing member 4 is guided to the most recessed portion of the second recess 21B.

The most recessed portion of the first recess 21A and the most recessed portion of the second recess 21B are arranged on the same line (on a line connecting the most recessed portions) in the X-axis direction of FIG. 2. As described above, the vertex of the first protrusion 11A is guided to the most recessed portion of the first recess 21A, and the vertex of the second protrusion 11B is guided to the most recessed of the second recess 21B. Accordingly, when the sealing member 4 is sandwiched between the case 2 and the cover 3, the sealing member 4 is appropriately positioned without requiring a special positioning operation and sufficiently exhibits sealing function. This positioning is also referred to as self-centering. At this time, the vertex (the most recessed portion) of the first recess 21A, the vertex (the most recessed portion) of the second recess 21B, the vertex (the most protruded portion) of the first protrusion 11A, and the vertex (the most protruded portion) of the second protrusion 11B are arranged on the same line. In other words, the line connecting the most recessed portions of the recesses corresponds to a line connecting the vertexes of the protrusions. While the sealing member 4 is sandwiched between the case 2 and the cover 3, before being compressed by the sealing member 4, the first protrusion 11A and the first recess 21A are in contact with each other at two points when viewed in cross section. Similarly, in the above state, the second protrusion 11B and the second recess 21B are in contact with each other at two points when viewed in cross section.

Accordingly, when the sealing member 4 is sandwiched between the case 2 and the cover 3, the sealing member 4 is positioned autonomously. Therefore, when the sealing member 4 is sandwiched between the case 2 and the cover 3, the sealing member 4 maintains upright posture without tilting in the Y-axis direction shown in FIG. 2. Such a configuration improves ease of mounting the sealing member 4.

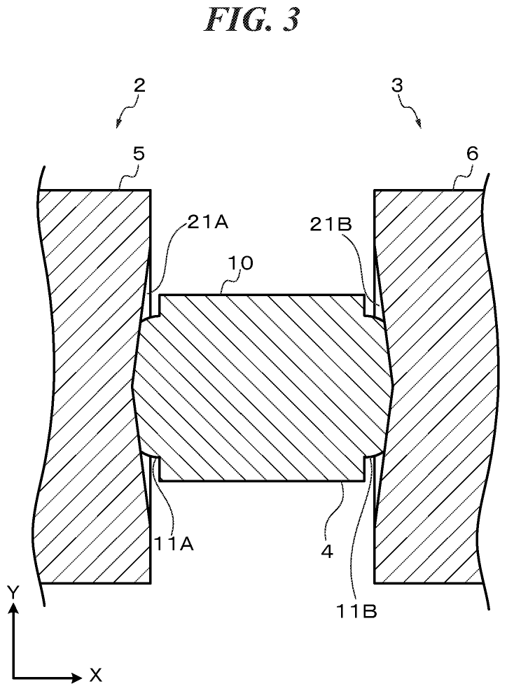

FIG. 3 is a cross-sectional view showing the seal structure when the case 2 and the cover 3 are fixed with the sealing member 4 being attached. As described above, when the sealing member 4 is sandwiched between the case 2 and the cover 3, the sealing member 4 is positioned autonomously and maintains upright posture. In this state, fixing the case 2 and the cover 3 narrows an interval between the case 2 and the cover 3, causing the sealing member 4 to be compressed under pressure from both the case 2 and the cover 3. When compressed by the case 2 and the cover 3, parts of the flexible sealing member 4 deform. As shown in the example of FIG. 3, when the first protrusion 11A is deformed, the first protrusion 11A is in close contact with the first recess 21A of the case 2, and when the second protrusion 11B is deformed, the second protrusion 11B is in close contact with the second recess 21B of the case 2. Accordingly, the sealing member 4 secures the sealing function.

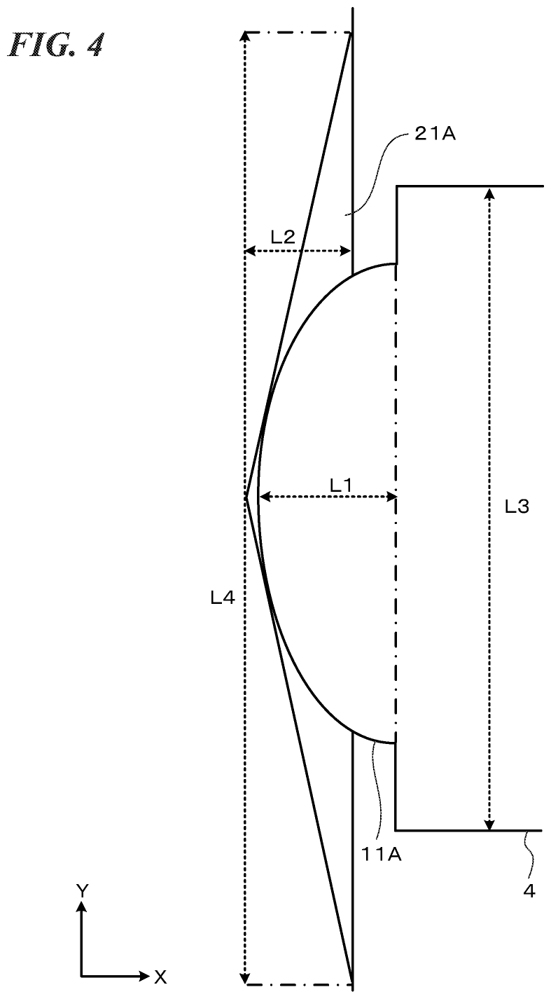

FIG. 4 is a partial expanded view of the seal structure shown in FIG. 2. FIG. 4 shows the first protrusion 11A and the first recess 21A, but it should be noted that the second protrusion 11B and the second recess 21B are similar to the first protrusion 11A and the first recess 21A. In FIG. 4, a height of the first protrusion 11A is referred to as “L1”, and a depth of the first recess 21A is referred to as “L2.” In this embodiment, the height L1 of the first protrusion 11A is longer than the depth L2 of the first recess 21A. As described above, when the case 2 and the cover 3 are fixed while the sealing member 4 is sandwiched between the case 2 and the cover 3, the sealing member 4 is compressed as shown in FIG. 3, causing the first protrusion 11A to be deformed. In this embodiment, since the height L1 of the first protrusion 11A is longer than the depth L2 of the first recess 21A, the first protrusion 11A thus becomes a part to be deformed during compression. Since the first protrusion 11A is a part to be deformed, an allowance for deformation is ensured by the first protrusion 11A. Accordingly, when the sealing member 4 is compressed, the main body 10 is prevented from being deformed.

Furthermore, a width L3 of the main body 10 of the sealing member 4 in the Y-axis direction (direction orthogonal to the X-axis direction) is shorter than a width L4 of the first recess 21A. In other words, the main body 10 of the sealing member 4 is smaller in size than the first recess 21A. For this reason, when the sealing member 4 is compressed, the first protrusion 11A is deformed, but the main body 10 is less likely to come into contact with the first recess 21A. Accordingly, when the sealing member 4 is compressed, the main body 10 is prevented from being deformed. In other words, in the seal structure of this embodiment, the first protrusion 11A and the second protrusion 11B disposed in the sealing member 4 have both a function of autonomously positioning the sealing member 4 and a function of ensuring an allowance for deformation when the sealing member 4 is compressed.

As described above, according to the seal structure of this embodiment, the first recess 21A is disposed in the case 2, and the second recess 21B is disposed in the cover 3. Furthermore, the first protrusion 11A and the second protrusion 11B are disposed in the sealing member 4. The first recess 21A and the first protrusion 11A are different in shape, and the second recess 21B and the second protrusion 11B are different in shape. Accordingly, when the sealing member 4 is sandwiched between the case 2 and the cover 3, the sealing member 4 has the first protrusion 11A in contact with the case 2 at two points and the second protrusion 11B in contact with the cover 3 at two points. Therefore, the sealing member 4 is positioned autonomously in an upright posture and secures sufficient sealing function even under a situation that causes a tilt of the sealing member 4. Furthermore, it is possible to improve the ease of mounting the sealing member 4.

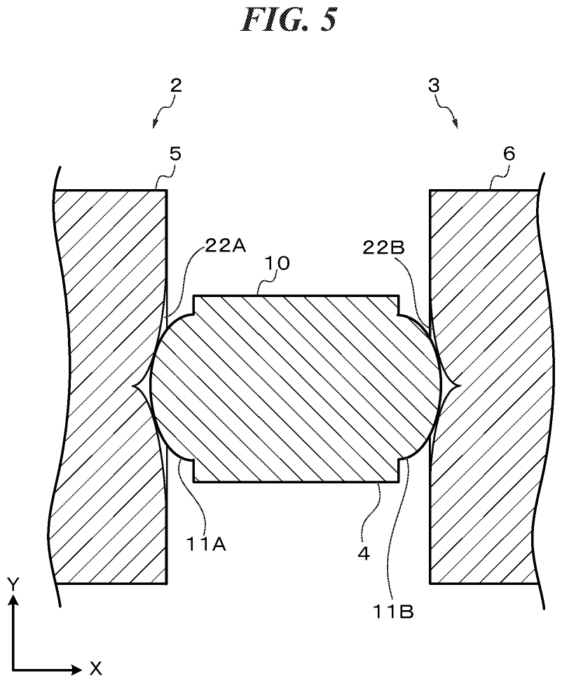

Next, each variation of this embodiment will be described. FIG. 5 is a cross-sectional view showing a seal structure according to a first variation. In the state of FIG. 5, a sealing member 4 is sandwiched between a case 2 and a cover 3, and the case 2 and the cover 3 are not fixed. Accordingly, the sealing member 4 is not compressed. As shown in FIG. 5, a first recess 22A and a second recess 22B according to the first variation each have a shape spreading out in curved lines starting from the most recessed portion. On the other hand, a first protrusion 11A has an arch-shaped cross section protruding toward the first recess 22A, and a second protrusion 11B has an arch-shaped cross section protruding toward the second recess 22B. Therefore, the first recess 22A and the first protrusion 11A are different in shape, and the second recess 22B and the second protrusion 11B are different in shape.

For this reason, the first protrusion 11A of the sealing member 4 comes into contact with the first recess 22A of the case 2 at two points. In addition, the second protrusion 11B of the sealing member 4 comes into contact with the second recess 22B of the cover 3 at two points. Accordingly, as in the embodiment, in the first variation, the sealing member 4 is positioned autonomously in an upright posture, which improves ease of mounting the sealing member 4.

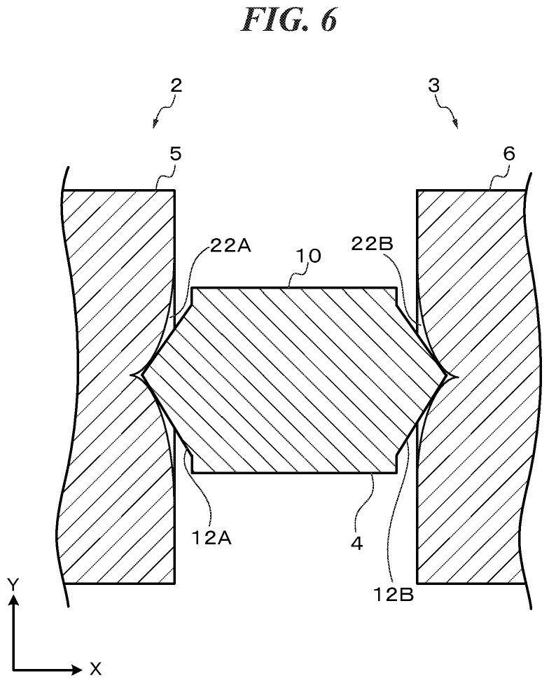

FIG. 6 is a cross-sectional view showing a seal structure according to a second variation. In the state shown in FIG. 6, a sealing member 4 is not compressed. In the second variation, as in FIG. 5, a first recess 22A and a second recess 22B each have a shape spreading out in curved lines starting from the most recessed portion. On the other hand, a first protrusion 12A and a second protrusion 12B of the sealing member 4 have a substantially triangular cross section. Even in this case, the first recess 22A and the first protrusion 12A are different in shape, and the second recess 22B and the second protrusion 11B are different in shape. For this reason, the first protrusion 12A of the sealing member 4 comes into contact with the first recess 22A of the case 2 at two points. In addition, the second protrusion 12B of the sealing member 4 comes into contact with the second recess 22B of the cover 3 at two points. Accordingly, it is possible to obtain effects similar to the embodiment and the first variation.

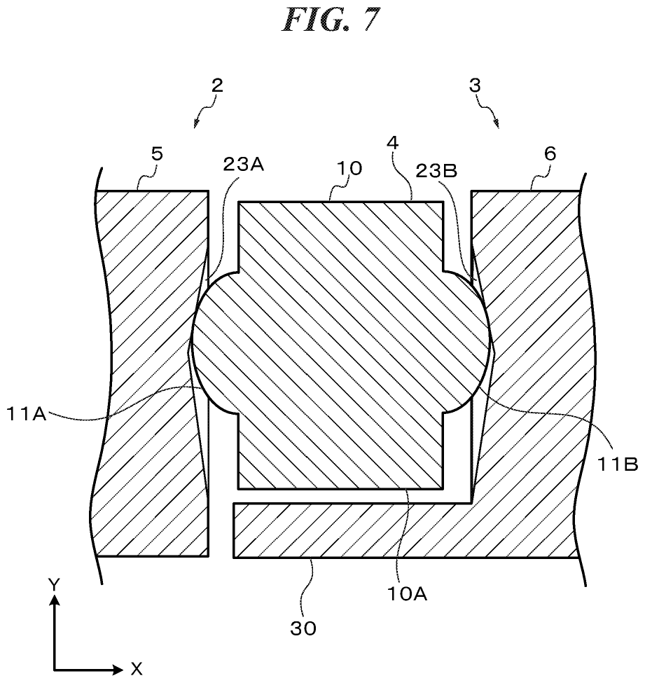

FIG. 7 is a cross-sectional view showing a seal structure according to a third variation. A first protrusion 11A and a second protrusion 11B of a sealing member 4 according to the third variation have a shape similar to one shown in FIG. 2. On the other hand, a first recess 23A and a second recess 23B according to the third variation are different in shape from those shown in FIG. 2. A second contact portion 6 is provided with an extension 30 extending from the second recess 23B toward a case 2 in the X-axis direction. It should be noted that a first contact portion 5 may be instead provided with another extension extending from the first recess 23A toward a cover 3 in the X-axis direction.

As shown in FIG. 7, the first recess 23A according to the third variation has a substantially V-shaped cross section, but the shape is asymmetric in the Y-axis direction. The first recess 23A is provided with two inclined planes spreading from the most recessed portion. In the two inclined planes, an inclined plane far from the extension 30 has an angle more acute than an inclined plane close to the extension 30. Similarly, the second recess 23B has a substantially V-shaped cross section, and the shape is asymmetric in the Y-axis direction. In the two inclined planes of the second recess 23B, an inclined plane far from the extension 30 has an angle more acute than an inclined plane close to the extension 30.

FIG. 7 shows a state where the sealing member 4 is sandwiched between a case 2 and the cover 3. When the sealing member 4 is sandwiched between the case 2 and the cover 3, the first protrusion 11A and the first recess 23A come into contact with each other at one point, and the second protrusion 11B and the second recess 23B come into contact with each other at one point. In this case, the sealing member 4 moves from a steep inclined plane toward a gentle inclined plane of the two inclined planes of each of the first recess 23A and the second recess 23B. The extension 30 is disposed in a direction in which the sealing member 4 moves. In other words, the extension 30 is disposed in the side close to the gentle inclined plane of the two inclined planes of each of the first recess 23A and the second recess 23B. Here, the vertex of the first recess 23A, the vertex of the second recess 23B, the vertex of the first protrusion 11A, and the vertex of the second protrusion 11B are not arranged on the same line. A line connecting the vertex of the first protrusion 11A and the vertex of the second protrusion 11B and a line connecting the vertex of the first recess 23A and the vertex of the second recess 23B are shifted in the Y-axis direction.

When the sealing member 4 moves, the first protrusion 11A of the sealing member 4 comes into contact with the first recess 23A at two points, and the second protrusion 11B comes into contact with the second recess 23B at two points. Accordingly, the sealing member 4 is positioned autonomously. Here, a surface of a main body 10 of the sealing member 4 that faces the extension 30 (hereinafter referred to as “opposing surface 10A”) and the extension 30 may come into contact with each other or may be slightly separated from each other.

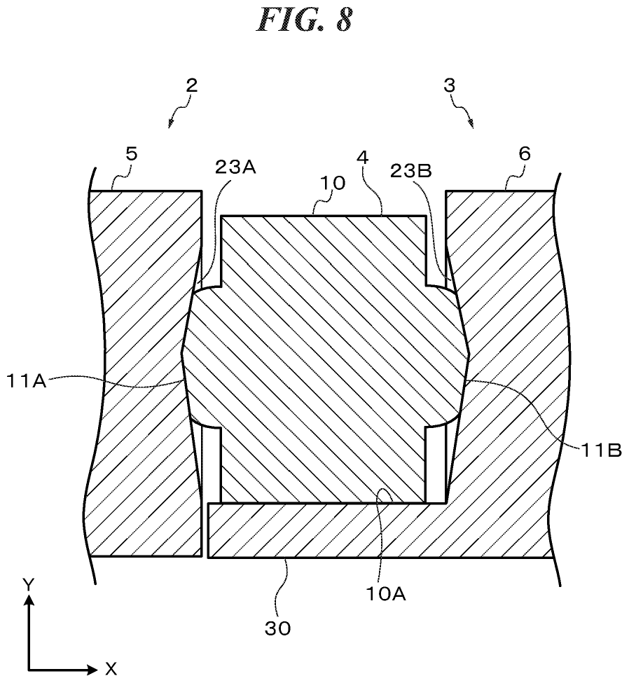

FIG. 8 is a cross-sectional view showing a state in which the case 2 and the cover 3 are fixed with the sealing member 4 being attached. In this case, pressure acts on the sealing member 4, which compresses the sealing member 4. Here, as described above, the first recess 23A and the second recess 23B have an asymmetric cross section in the Y-axis direction, and the inclined plane far from the extension 30 has an angle more acute than the inclined plane close to the extension 30. Accordingly, when the sealing member 4 is compressed, not only pressure in the X-axis direction acts on the sealing member 4, but also force toward the extension 30 acts on the sealing member 4. For this reason, when the sealing member 4 is compressed, the opposing surface 10A of the main body 10 comes into contact with the extension 30, and the main body 10 presses the extension 30. At this time, the vertex of the first recess 23A, the vertex of the second recess 23B, the vertex of the first protrusion 11A, and the vertex of the second protrusion 11B are arranged on the same line. The line connecting the vertex of the first protrusion 11A and the vertex of the second protrusion 11B and the line connecting the vertex of the first recess 23A and the vertex of the second recess 23B are coincided with each other in the Y-axis direction. In the embodiment and each variation described above, when the sealing member 4 is compressed, the vertex of the recess of the case 2, the vertexes of the two protrusions of the sealing member 4, and the vertex of the recess of the cover 3 are preferably arranged on the same line.

Accordingly, not only the first protrusion 11A and the first recess 23A, and the second protrusion 11B and the second recess 23B, but also the main body 10 and the extension 30 are in close contact with each other. Such a configuration improves sealing function. In the example shown in FIG. 8, the extension 30 has a length long enough to come into contact with the entire opposing surface 10A of the main body 10 of the sealing member 4 in the X-axis direction.

In this respect, the extension 30 may have a length long enough to come into contact with part of the opposing surface 10A of the main body 10 of the sealing member 4 in the X-axis direction. Even in this case, it is possible to secure the sealing function at a part where the main body 10 presses the extension 30. However, having a length long enough to be pressed by the entire opposing surface 10A of the main body 10 of the sealing member 4 in the X-axis direction, the extension 30 is sealed by the entire opposing surface 10A of the sealing member 4. Accordingly, the extension 30 preferably has a length long enough to come into contact with the entire opposing surface 10A of the main body 10 of the sealing member 4 in the X-axis direction.

This application claims the benefit of Japanese Patent Application No. 2019-041774 filed on Mar. 7, 2019 which is hereby incorporated by reference herein in its entirety.

What is claimed is:

1. A seal structure and a switch device comprising:
a first member;
a second member;
a sealing member on which pressure acts while being sandwiched between the first member and the second member;
wherein the sealing member includes a main body, a first protrusion protruding from the main body toward the first member, and a second protrusion protruding from the main body toward the second member,
the first member includes a first recess that comes into contact with the first protrusion,
the second member includes a second recess that comes into contact with the second protrusion,
the first protrusion and the first recess are different in shape, and
the second protrusion and the second recess are different in shape.

2. The seal structure according to claim 1, wherein a vertex of the first recess, a vertex of the second recess, a vertex of the first protrusion, and a vertex of the second protrusion are arranged on the same line.

3. The seal structure according to claim 2, wherein the first protrusion and the second protrusion each have an arch-shaped cross section, and the first recess and the second recess each have a substantially V-shaped cross section.

4. The seal structure according to claim 2, wherein the first protrusion and the second protrusion each have an arch-shaped cross section, and the first recess and the second recess each have a cross section spreading out in curved lines starting from the most recessed portion.

5. The seal structure according to claim 2, wherein the first protrusion and the second protrusion each have a substantially triangular cross section, and the first recess and the second recess each have a cross section spreading out in curved lines starting from the most recessed portion.

6. The seal structure according to claim 1, wherein the first protrusion and the second protrusion each have an arch-shaped cross section,
the first recess and the second recess each have an asymmetrical substantially V-shaped cross section, and
the seal structure further comprises an extension extending from the first member or the second member, the extension being disposed in a direction in which the sealing member moves when the pressure acts on the sealing member.

7. The seal structure according to claim 6, wherein the extension comes into contact with an entire opposing surface of the main body, the opposing surface being a side surface facing the extension.

8. The seal structure according to claim 1, wherein the first protrusion has a height larger than a depth of the first recess, and the second protrusion has a height larger than a depth of the second recess.

9. The seal structure according to claim 1, wherein the main body has a width narrower than a width of the first recess and a width of the second recess.

10. A switch device comprising the seal structure according to claim 1.
